(19) United States
(12) Patent Application Publication
(10) Pub. No.: US 2024/0073790 A1
(43) Pub. Date: Feb. 29, 2024

(54) SELECTIVE SEARCHING FOR WIRELESS NETWORKS

(71) Applicant: Charter Communications Operating, LLC, St. Louis, MO (US)

(72) Inventors: Mohamed Daoud, Englewood, CO (US); Hany Heikal, Aurora, CO (US); Muhammad Khan, Greenwood Village, CO (US); Hossam Hmimy, Aurora, CO (US)

(73) Assignee: Charter Communications Operating, LLC, St. Louis, MO (US)

(21) Appl. No.: 17/822,848

(22) Filed: Aug. 29, 2022

(51) Int. Cl. H04W 48/16; H04W 4/02; H04W 8/02

(52) U.S. Cl. CPC H04W 48/16; H04W 4/025; H04W 8/02; H04W 88/06

(57) ABSTRACT

A wireless device (e.g., a cell phone) having a first SIM card for a first (e.g., private) wireless network and a second SIM card for a second (e.g., public) wireless network. The wireless device disables searching for the first wireless network if its current location is outside of a defined coverage region for the first wireless network, thereby saving battery power. The defined coverage region may be defined by minimum and maximum longitude and latitude values that superscribe the overall coverage area of the first wireless network. The network server for the first wireless network transmits a definition of a defined coverage region for the wireless network and automatically updates the defined coverage region when the overall coverage area of the first wireless network is modified, such as when a new access point is added to the network.

### BACKGROUND

### Field of the Disclosure

The present disclosure relates to wireless (e.g., LTE/5G) communication systems.

### Description of the Related Art

This section introduces aspects that may help facilitate a better understanding of the disclosure. Accordingly, the statements of this section are to be read in this light and are not to be understood as admissions about what is prior art or what is not prior art.

It is known for a wireless device, such as a cell phone and the like, to be provisioned with two Subscriber Identity Module (SIM) cards and/or two eSIMs: one for a public wireless network having a relatively wide geographic coverage area and the other for a private wireless network having a relatively small geographic coverage area (e.g., factory, enterprise, warehouse, school) that is located within the coverage area of the public network. It is also known to configure such a two-SIM wireless device to be configured to have a default preference for the private network. If the wireless device is able to connect to the private network, then the wireless device will automatically use its corresponding private-network SIM card to connect to and communicate via the private network. If the wireless device is not able to connect to the private network, then the wireless device will automatically use its corresponding public-network SIM card to connect to and communicate via the public network.

### SUMMARY

It is also known for such a two-SIM wireless device to be configured to periodically search for the private network. As a result, if and when the wireless device is located within the coverage area of the private network, the wireless device will automatically connect to and communicate via the private network. Unfortunately, if and when the wireless device is located outside of the coverage area of the private network, even when the wireless device is already connected to the public network, the wireless device will periodically search for and try to connect to the private network. This periodic private-network searching, which can involve the wireless device changing frequency and temporarily disconnecting from the public network to search for other frequencies, synchronize on the frame and slot level (RACH process), and then decode the Master Information Block (MIB) and System Information Block (SIB) messages, will result in significant drainage of the device's battery power, thereby severely limiting the time between necessary recharging of the battery.

Problems in the prior art are addressed in accordance with the principles of the present disclosure by configuring a two-SIM wireless device with information about the geographic coverage area of its private network. Based on knowledge of the private network's defined coverage region and knowledge of its own location from its GPS receiver, the wireless device automatically determines whether it is outside of the private network's defined coverage region. If so, then the wireless device does not periodically search for and try to connect to the private network. Only when the wireless device determines that it is not outside of the private network's defined coverage region will the wireless device periodically search for and try to connect to the private network. In this way, the drainage of the wireless device's battery will be significantly reduced, thereby enabling the wireless device to be recharged less frequently.

In one embodiment of the present disclosure, a wireless device comprises a processor, at least one wireless transceiver, a GPS receiver, a first SIM card for a first wireless network, and a second SIM card for a second wireless network. The processor is configured to control operations of the wireless transceiver using the first or second SIM card and the GPS receiver to cause the wireless device to receive a definition of a defined coverage region for the first wireless network; determine a current location of the wireless device; determine whether the current location of the wireless device is outside of the defined coverage region for the first wireless network; and disable searching for the first wireless network if the current location of the wireless device is determined to be outside of the defined coverage region for the first wireless network.

In another embodiment of the present disclosure, a wireless network comprises a network server and one or more access points. The network server controls operations of the one or more access points to cause the wireless network to communicate with one or more wireless devices and transmits a definition of a defined coverage region for the wireless network.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified block diagram of a private network according to certain embodiments of the disclosure;

FIG. 2 is a diagram representing the overall coverage area of a simple, idealized example of the private network of FIG. 1;

FIG. 3 is a simplified block diagram of a wireless UE device according to certain embodiments of the disclosure;

FIG. 4 is a simplified flow diagram of certain processing performed by the wireless device of FIG. 3;

FIG. 5 is a diagram representing the overall coverage area 200′ of the private network 100 of FIG. 1 after the addition of two new APs; and

FIG. 6 is a flow diagram of the processing automatically performed by the PN server of FIG. 1 to generate the updated definition of the private network's defined coverage region when a new AP is added to the private network.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

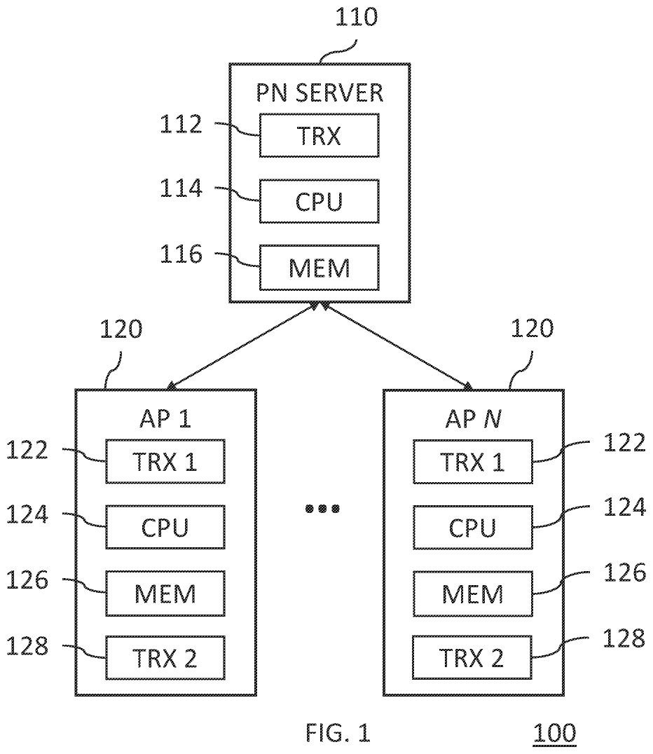

FIG. 1 is a simplified block diagram of a private network (PN) 100 according to certain embodiments of the disclosure. As shown in FIG. 1, the private network 100 includes a PN server 110 that controls the operations of the private network's access points (APs) 120 that communicate wirelessly with one or more wireless user equipment (UE) devices (not shown) that are located within the coverage area of the private network 100.

As shown in FIG. 1, the PN server 110 includes at least one (wired, optical, or wireless) transceiver (TRX) 112 for communicating with the APs 120, processor (e.g., CPU) 114, and memory 116. The processor 114 controls the incoming and outgoing wireless communications by the TRX 112 based on programming code stored in the memory 116. Each AP 120 includes first (wired, optical, or wireless) transceiver (TRX 1) 122 for communicating with the PN server 110, processor 124, memory 126, and a second (wireless) transceiver (TRX 2) 128 for communicating with one or more wireless devices. The processor 124 controls the incoming and outgoing communications by the first and second TRXs 122 and 128 based on programming code stored in the memory 126. Those skilled in the art will understand that the PN server 110 and each AP 120 may include additional components not shown in FIG. 1.

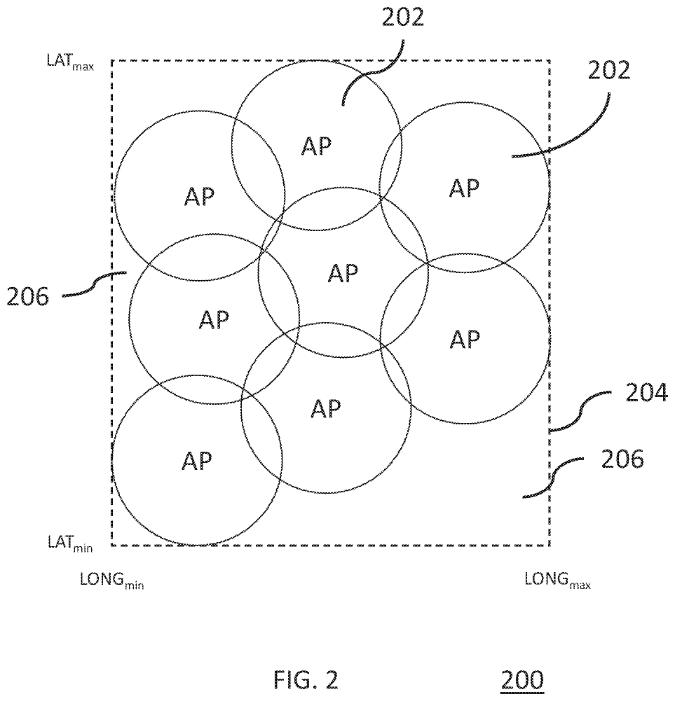

FIG. 2 is a diagram representing the overall coverage area 200 of a simple, idealized example of the private network 100 of FIG. 1 having eight APs 120, where each AP has a circular coverage area 202 of the same size and where the private network's overall coverage area 200 is formed by the union of the individual coverage areas 202 of the eight access points APs. Those skilled in the art will understand that, in real-world implementations, the coverage areas for different APs vary in both size and shape.

In certain embodiments of the disclosure, the defined coverage region for a private network is defined by the minimum and maximum longitudes and latitudes of a rectangular area that superscribes the overall coverage area 200. As shown in FIG. 2, the private network's defined coverage region 204 is defined by the minimum longitude LONGₘᵢₙ, the maximum longitude LONGₘₐₓ, the minimum latitude LATₘᵢₙ, and the maximum latitude LATₘₐₓ of the overall coverage area 200, where longitude values range from 0 degrees to 360 degrees relative to the Greenwich meridian and latitude values range from −90 degrees at the South Pole to +90 degrees at the North Pole with 0 degrees at the equator.

As used herein, the term “overall coverage area” refers to the union of the coverage areas of the private network's individual APs and therefore corresponds to the geographic region within which a wireless device can connect to and communicate via the private network, while the term “defined coverage region” refers to a defined region, such as the region 204 of FIG. 2, that superscribes the overall coverage area. As shown in FIG. 2, in addition to the overall coverage area 200, the defined coverage region 204 includes a number of non-coverage regions 206 that are outside of the overall coverage area 200 and therefore within which a wireless device will not be able to reliably connect to the private network.

Note that, if the overall coverage area 200 spans across the Greenwich meridian, then the minimum longitude LONGₘᵢₙ for the corresponding defined coverage region 204 will be a small value close to 0 degrees, while the maximum longitude LONGₘₐₓ will be a large value close to 360 degrees. One way to handle this situation is to use (−LONGₘᵢₙ) for the minimum longitude value and (360-LONGₘₐₓ) for the maximum longitude value of the defined coverage region 204, so that the minimum and maximum longitude values will be relative to the Greenwich meridian of 0 degrees. For example, if the minimum longitude for an overall coverage area 200 that spans the Greenwich meridian is at 0.01 degrees and the maximum longitude is at 359.99 degrees, then the defined coverage region 204 may be defined to have a minimum longitude value LONGₘᵢₙ of −0.01 degrees and the maximum longitude value LONGₘₐₓ of (360-359.99) or +0.01 degrees.

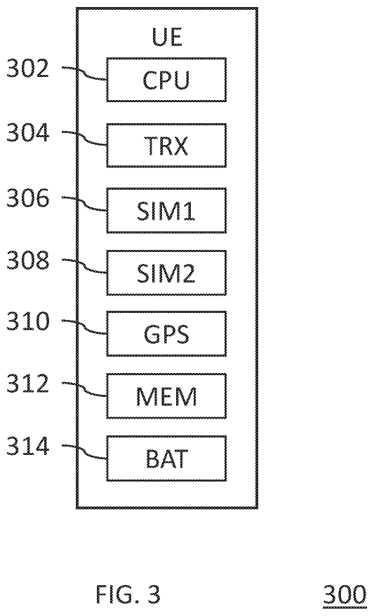

FIG. 3 is a simplified block diagram of a wireless UE device 300 according to certain embodiments of the disclosure. As shown in FIG. 3, the wireless device 300 includes processor (e.g., CPU) 302, wireless transceiver (TRX) 304, public-network SIM card (SIM1) 306, private-network SIM card (SIM2) 308, GPS receiver 310, memory 312, and battery 314. In these embodiments, the same transceiver 304 is capable of supporting either (i) wireless communications with APs of a public network using the public-network SIM card 306 or (ii) wireless communications with APs of a private network, such as the APs 120 of the private network 100 of FIG. 1, using the private-network SIM card 308. The processor 302 controls the incoming and outgoing communications of the transceiver 304 based on programming code stored in the memory 312. The battery 314 provides operating power for the other components of the wireless device 300. Those skilled in the art will understand that the wireless device 300 may include additional components not shown in FIG. 3.

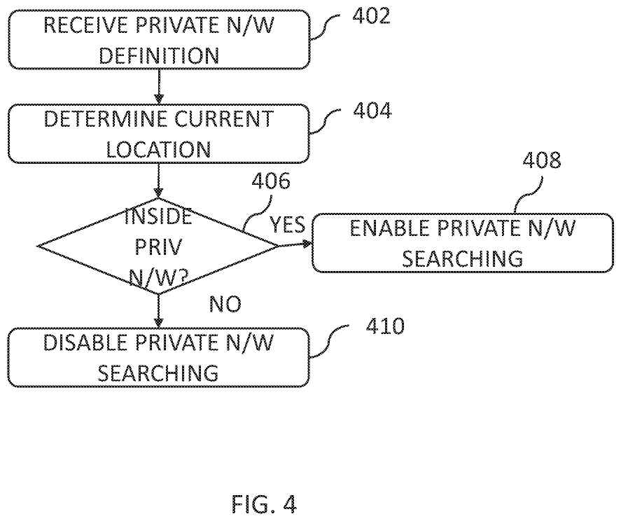

FIG. 4 is a simplified flow diagram of certain processing performed by the wireless device 300 of FIG. 3. According to certain implementations of the disclosure, a private network periodically broadcasts the parameters defining its defined coverage region. For example, the private network 100 of FIG. 1 would periodically broadcast the minimum and maximum longitude and latitude values for its defined coverage region 204 of FIG. 2. If the wireless device 300 is within the overall coverage area 200 of its private network during one of those periodic broadcasts, then, in step 402 of FIG. 4, the wireless device 300 will receive and store the parameters of the defined coverage region 204 for its private network in its memory 312.

In step 404, the wireless device 300 uses its GPS receiver 310 to determine its current location in terms of longitude and latitude and, in step 406, the wireless device 300 determines whether it is located inside or outside of its private network's defined coverage region 204 of FIG. 2 by comparing the longitude and latitude of its current location to the minimum and maximum longitude and latitude values of its defined coverage region 204. If its current longitude is between the minimum and maximum longitude values and if its current latitude is between the minimum and maximum latitude values, then the wireless device 300 determines that it is currently located within its private network's defined coverage region 204 and, in step 408, the wireless device 300 will enable its periodic searching for the private network. Otherwise, the wireless device 300 determines that it is not located within its private network's defined coverage region 204 and, in step 410, the wireless device 300 will disable its periodic searching for the private network.

In this way, the wireless device 300 will avoid searching for its private network when it is located outside of its private network's defined coverage region 204 of FIG. 2, thereby avoiding wasting much battery power. As described above, the rectangular defined coverage region 204 for the private network includes a number of non-coverage areas 206 that are outside of the private network's overall coverage area 200 formed by the individual coverage areas 202 of the private network's APs. As such, if the wireless device 300 is located within one of those non-coverage areas 206, then the wireless device 300 will search for its private network without necessarily being able to connect to it.

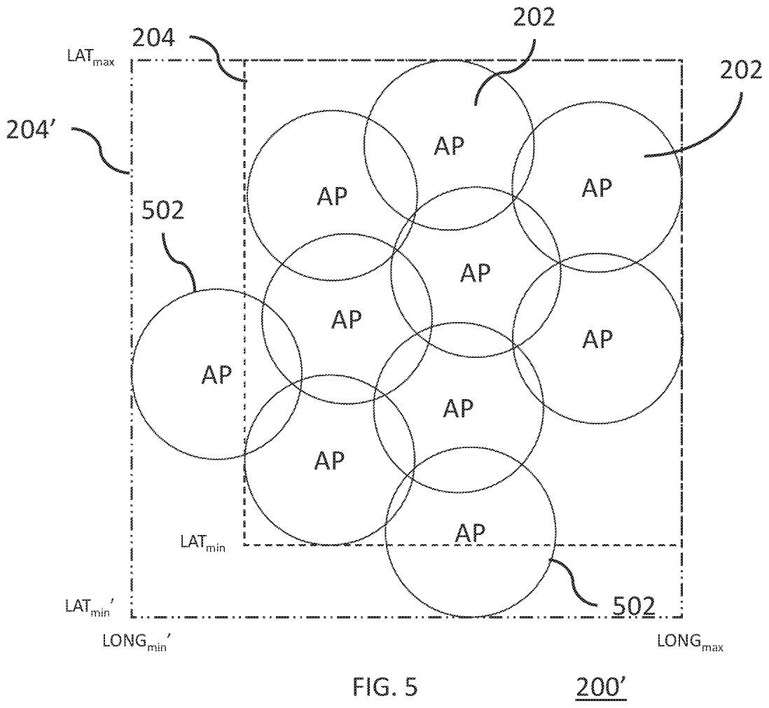

FIG. 5 is a diagram representing the overall coverage area 200′ of the private network 100 of FIG. 1 after the addition of two new APs 120 having coverage areas 502. In this example, the defined coverage region 204′ of the augmented private network is different from the defined coverage region 204 of FIG. 2. In particular, in this example, the new defined coverage region 204′ has different minimum longitude and latitude values LONGₘᵢₙ′ and LATₘᵢₙ′, but the same maximum longitude and latitude values LONGₘₐₓ and LATₘₐₓ as the defined coverage region 204 of FIG. 2.

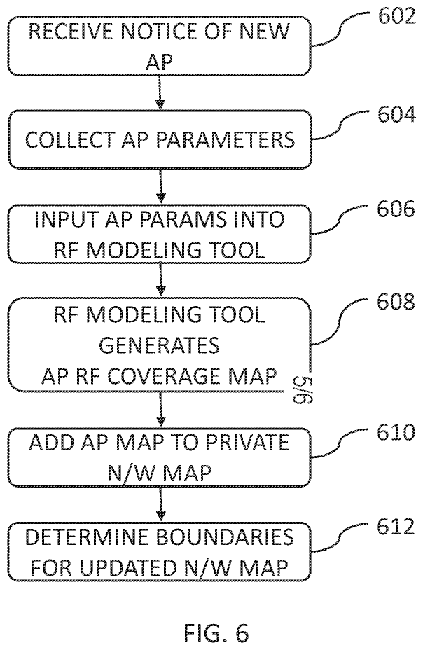

FIG. 6 is a flow diagram of the processing automatically performed by the PN server 110 of FIG. 1 to generate the updated definition of the private network's defined coverage region when a new AP is added to the private network. The processing of FIG. 6 is to be repeated for each new AP.

In step 602, the PN server 110 receives notice of the existence of the new AP. In step 604, the PN server 110 collects certain parameters associated with the new AP, such as (without limitation) one or more of transmission frequency, location of the new AP, transmit power level, antenna gain, cable loss, antenna pattern, radio noise figure, receiver sensitivity, floor plan/morphology of area to be covered. In some implementations, the PN server 110 receives some or all of this information directly from the new AP and/or from one or more other sources inside or outside of the private network.

In step 606, the PN server 110 inputs the collected AP parameters into an RF modeling tool hosted either on the PN server 110 or on another node inside or outside of the private network and, in step 608, the RF modeling tool uses those AP parameters to generate an RF coverage map for the new AP. In some implementations, the RF modeling tool may be one of the iBwave Design RF modeling tool by iBwave Solutions Inc. of Montreal, Canada, the Atoll RF modeling tool of Forsk of Blagnac, France, and the Planet RF modeling tool of Infovista of Ashburn, Virginia.

In step 610, the PN server 110 combines the RF coverage map for the new AP with the existing RF coverage map for the private network's overall coverage area and, in step 612, as needed, the PN server 110 determines new boundaries (e.g., minimum and/or maximum longitude and/or latitude values) for the private-network's augmented defined coverage region.

In the implementations described above, the defined coverage region superscribing the private network's overall coverage area is characterized by minimum and maximum longitude and latitude values and is therefore rectangular in shape. In other implementations, the superscribing defined coverage region may be characterized differently. For example, in certain other implementations, the defined coverage region may be, for example, (i) a superscribing circular region having a specified center location and a specified radius or (ii) a superscribing elliptical region having two specified loci locations and a specified eccentricity. Those skilled in the art will understand that other superscribing shapes may be employed for the defined coverage region, some of which will have fewer and/or smaller non-coverage areas, such as the non-coverage areas 206 of FIG. 2.

As used in the claims, the term “SIM card” is intended to cover either a conventional SIM card implementation or an eSIM implementation.

Although the disclosure has been described in the context of a wireless device having two SIM cards and a single transceiver that can operate with either SIM card, in general, wireless devices of the disclosure may have two or more SIM cards and one or more transceivers, where each transceiver can operate with one or more of the SIM cards.

Although the disclosure has been described in the context of a two-SIM wireless device that can communicate via either a public network or a private network, in general, embodiments of the disclosure may involve wireless devices having two or more SIMs corresponding to two or more different wireless networks, whether they are public or private.

Although the disclosure has been described in the context of a wireless network that periodically broadcasts parameters for its defined coverage region, in other implementations, the wireless network may unicast those parameters one or more times to each different wireless device that is connected to the wireless network. In either case, since the definition of the defined coverage region can change over time, each different wireless device will update its stored parameters whenever they have changed.

In certain embodiments of the present disclosure, a wireless device comprises a processor, at least one wireless transceiver, a GPS receiver, a first SIM card for a first wireless network, and a second SIM card for a second wireless network. The processor is configured to control operations of the wireless transceiver using the first or second SIM card and the GPS receiver to cause the wireless device to receive a definition of a defined coverage region for the first wireless network; determine a current location of the wireless device; determine whether the current location of the wireless device is outside of the defined coverage region for the first wireless network; and disable searching for the first wireless network if the current location of the wireless device is determined to be outside of the defined coverage region for the first wireless network.

In at least some of the above embodiments, the wireless device enables searching for the first wireless network if the current location of the wireless device is determined to be inside of the defined coverage region for the first wireless network.

In at least some of the above embodiments, when searching for the first wireless network is enabled, the wireless device is configured to periodically search for the first wireless network even when the wireless device is already connected to the second wireless network.

In at least some of the above embodiments, the defined coverage region is defined by minimum and maximum longitude and latitude values for the first wireless network.

In at least some of the above embodiments, the first wireless network is a private wireless network for the wireless device, and the second wireless network is a public wireless network for the wireless device.

In at least some of the above embodiments, when searching for the first wireless network is enabled, the wireless device is configured to prioritize connection to the private wireless network over connection to the public wireless network.

In certain embodiments of the present disclosure, a wireless network comprises a network server and one or more access points. The network server controls operations of the one or more access points to cause the wireless network to communicate with one or more wireless devices and transmit a definition of a defined coverage region for the wireless network.

In at least some of the above embodiments, the wireless network periodically broadcasts the definition of its defined coverage region.

In at least some of the above embodiments, the defined coverage region is defined by minimum and maximum longitude and latitude values for the wireless network.

In at least some of the above embodiments, the wireless network is a private wireless network for the one or more wireless devices.

In at least some of the above embodiments, the network server is configured to automatically update the definition of its defined coverage region whenever a new access point is added to the wireless network.

In at least some of the above embodiments, after the network server receives notice of the existence of the new access point, the network server automatically collects parameters for the new access point; runs an RF modeling tool based on the collected parameters to generate an RF coverage map for the new access point; adds the RF coverage map for the new access point to an existing RF coverage map for the wireless network to generate an updated RF coverage map for the wireless network; and updates the definition of its defined coverage region based on the updated RF coverage map.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

As used herein in reference to an element and a standard, the terms “compatible” and “conform” mean that the element communicates with other elements in a manner wholly or partially specified by the standard, and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, when the program code is loaded into and executed by a machine, such as a computer, the machine becomes an apparatus for practicing the disclosure. When implemented on a general-purpose processor, the program code segments combine with the processor to provide a unique device that operates analogously to specific logic circuits.

The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A wireless device comprising:
a processor;
at least one wireless transceiver;
a GPS receiver;
a first SIM card for a first wireless network; and
a second SIM card for a second wireless network, wherein the processor is configured to control operations of the wireless transceiver using the first or second SIM card and the GPS receiver to cause the wireless device to:
receive a definition of a defined coverage region for the first wireless network;
determine a current location of the wireless device;
determine whether the current location of the wireless device is outside of the defined coverage region for the first wireless network; and
disable searching for the first wireless network if the current location of the wireless device is determined to be outside of the defined coverage region for the first wireless network.

2. The wireless device of claim 1, wherein the wireless device enables searching for the first wireless network if the current location of the wireless device is determined to be inside of the defined coverage region for the first wireless network.

3. The wireless device of claim 2, wherein, when searching for the first wireless network is enabled, the wireless device is configured to periodically search for the first wireless network even when the wireless device is already connected to the second wireless network.

4. The wireless device of claim 1, wherein the defined coverage region is defined by minimum and maximum longitude and latitude values for the first wireless network.

5. The wireless device of claim 1, wherein:
the first wireless network is a private wireless network for the wireless device; and
the second wireless network is a public wireless network for the wireless device.

6. The wireless device of claim 5, wherein, when searching for the first wireless network is enabled, the wireless device is configured to prioritize connection to the private wireless network over connection to the public wireless network.

7. A wireless network comprising:
a network server; and
one or more access points, wherein the network server controls operations of the one or more access points to cause the wireless network to:
communicate with one or more wireless devices; and
transmit a definition of a defined coverage region for the wireless network.

8. The wireless network of claim 7, wherein the wireless network periodically broadcasts the definition of its defined coverage region.

9. The wireless network of claim 7, wherein the defined coverage region is defined by minimum and maximum longitude and latitude values for the wireless network.

10. The wireless network of claim 7, wherein the wireless network is a private wireless network for the one or more wireless devices.

11. The wireless network of claim 7, wherein the network server is configured to automatically update the definition of its defined coverage region whenever a new access point is added to the wireless network.

12. The wireless network of claim 11, wherein, after the network server receives notice of the existence of the new access point, the network server automatically:
collects parameters for the new access point;
runs an RF modeling tool based on the collected parameters to generate an RF coverage map for the new access point;
adds the RF coverage map for the new access point to an existing RF coverage map for the wireless network to generate an updated RF coverage map for the wireless network; and
updates the definition of its defined coverage region based on the updated RF coverage map.

13. A method for a wireless device comprising a processor, at least one wireless transceiver, a GPS receiver, a first SIM card for a first wireless network, and a second SIM card for a second wireless network, wherein the method comprises the wireless device:
receiving a definition of a defined coverage region for the first wireless network;
determining a current location of the wireless device;
determining whether the current location of the wireless device is outside of the defined coverage region for the first wireless network; and
disabling searching for the first wireless network if the current location of the wireless device is determined to be outside of the defined coverage region for the first wireless network.

14. The method of claim 13, wherein the wireless device enables searching for the first wireless network if the current location of the wireless device is determined to be inside of the defined coverage region for the first wireless network.

15. The method of claim 14, wherein, when searching for the first wireless network is enabled, the wireless device periodically searches for the first wireless network even when the wireless device is already connected to the second wireless network.

16. The method of claim 13, wherein the defined coverage region is defined by minimum and maximum longitude and latitude values for the first wireless network.

17. The method of claim 13, wherein:
the first wireless network is a private wireless network for the wireless device; and
the second wireless network is a public wireless network for the wireless device.

18. The method of claim 17, wherein, when searching for the first wireless network is enabled, the wireless device prioritizes connection to the private wireless network over connection to the public wireless network.

19. A method for a wireless network comprising a network server and one or more access points, wherein the method comprises the wireless network:
communicating with one or more wireless devices; and
transmitting a definition of a defined coverage region for the wireless network.

20. The method of claim 19, wherein the wireless network periodically broadcasts the definition of its defined coverage region.

21. The method of claim 19, wherein the defined coverage region is defined by minimum and maximum longitude and latitude values for the wireless network.

22. The method of claim 19, wherein the wireless network is a private wireless network for the one or more wireless devices.

23. The method of claim 19, wherein the network server automatically updates the definition of its defined coverage region whenever a new access point is added to the wireless network.

24. The method of claim 23, wherein, after the network server receives notice of the existence of the new access point, the network server automatically:
collects parameters for the new access point;
runs an RF modeling tool based on the collected parameters to generate an RF coverage map for the new access point;
adds the RF coverage map for the new access point to an existing RF coverage map for the wireless network to generate an updated RF coverage map for the wireless network; and
updates the definition of its defined coverage region based on the updated RF coverage map.
